(19) United States
(12) Patent Application Publication
(10) Pub. No.: US 2013/0152219 A1
(43) Pub. Date: Jun. 13, 2013

(54) ELECTRONIC DEVICE WITH FILE LOCKING FUNCTION AND METHOD THEREOF

(71) Applicant: HONG-YU YANG, Shenzhen City (CN)

(72) Inventor: HONG-YU YANG, Shenzhen City (CN)

(73) Assignees: HON HAI PRECISION INDUSTRY CO., LTD., Tu-Cheng (TW); Hong Fu Jin Precision Industry (ShenZhen) Co., Ltd, Shenzhen City (CN)

(21) Appl. No.: 13/407,777

(22) Filed: Feb. 29, 2012

(30) Foreign Application Priority Data
Dec. 9, 2011 (CN) 201110408541.4

(51) Int. Cl. G06F 21/24; G06F 17/30

(52) U.S. Cl. 726/30; 726/27

(57) ABSTRACT

An electronic device includes a data storage, a display unit, and a processing unit. The data storage stores a plurality of files. The display unit is operable to display drawing interfaces. The electronic device selects a file requiring locking, activates a drawing tool to generate the drawing interface in response to an file locking operation, records an image file drawn by the drawing tool as a locking password following a drawing operation on the drawing interface, and associates the file with the locking password to lock the file.

### BACKGROUND

1. Technical Field

The present disclosure relates to an electronic device with a file locking function and a method thereof.

2. Description of Related Art

A file may be locked by: generating a dialog box to prompt user to input password in response to an file locking operation, and locking the file according to the input password. If the password is a combination of characters, it is easily unlocked if a simple password is set. If the password is complex, the password is difficult to remember.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with a file locking function in accordance with an exemplary embodiment.

FIG. 2 is a flowchart of a method for locking a file implemented by the electronic device of FIG. 1.

FIG. 3 is a schematic diagram of a drawing interface for drawing a locking password image.

FIG. 4 is a flowchart of method to unlock the locked file in accordance with a first embodiment.

FIG. 5 is a schematic diagram of a drawing interface for drawing an unlocking password image.

FIG. 6 is a flowchart of method to unlock the locked file in accordance with a second embodiment.

### DETAILED DESCRIPTION

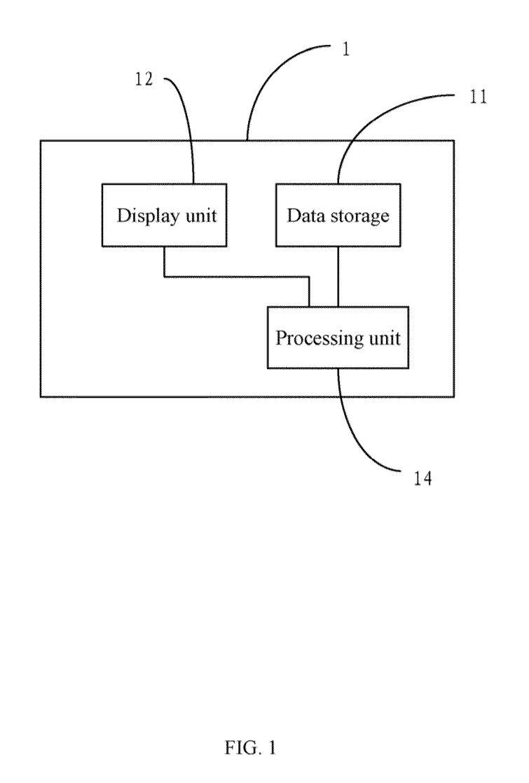

FIG. 1 is a block diagram of an electronic device 1 with a file locking function in accordance with an exemplary embodiment. The electronic device 1 includes a data storage 11, a display unit 12, and a processing unit 14. The data storage 11 stores a number of files. The display unit 12 displays interfaces for locking/unlocking the files. The processing unit 14 is for locking or unlocking the file stores in the data storage 11.

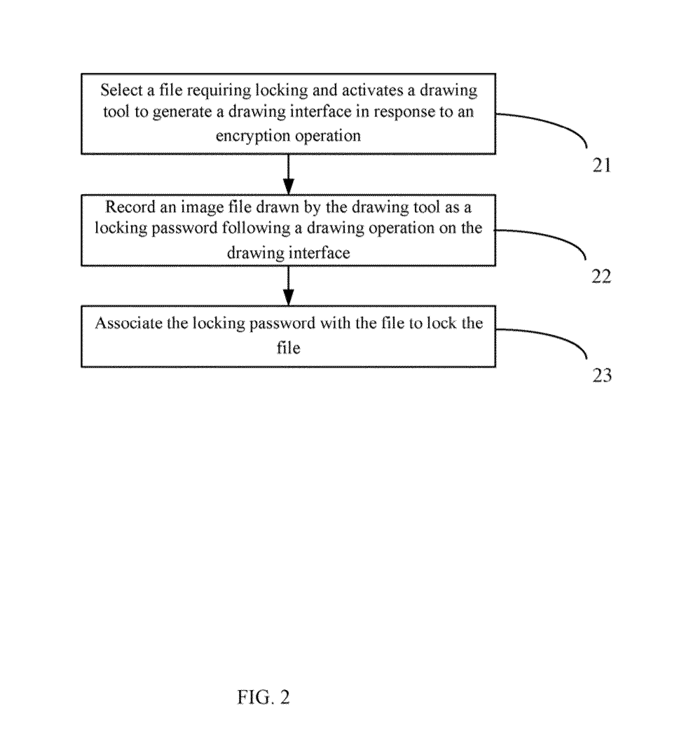

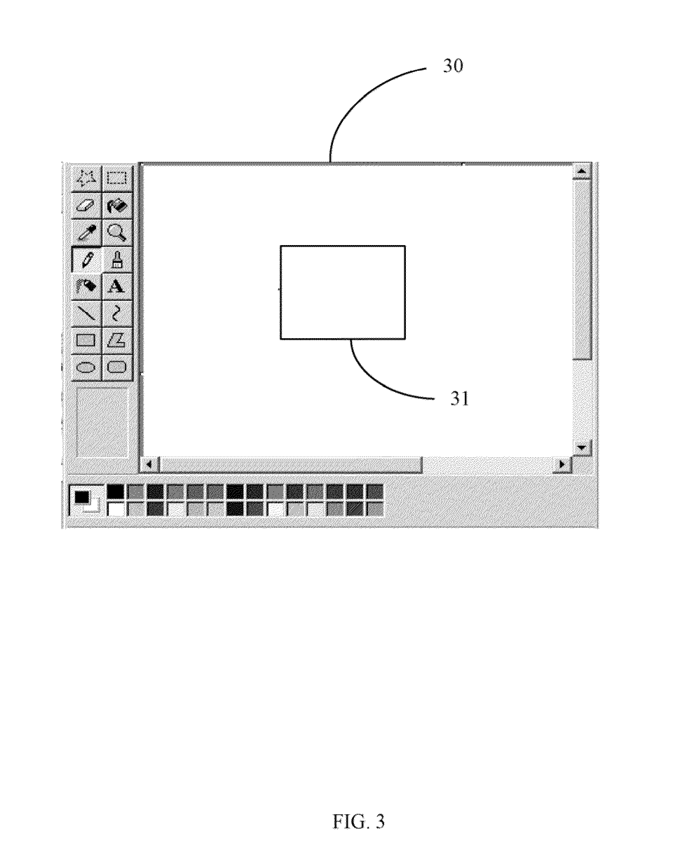

FIG. 2 is a flowchart of a method for locking the file by the processing unit 12. In step S21, the processing unit 12 selects a file requiring locking and activates a drawing tool to generate a drawing interface 30 as shown in FIG. 3 in response to an encryption operation. The drawing tool is preinstalled in the electronic device 1.

In step S22, the processing unit 14 records an image file drawn by the drawing tool as a locking password following a drawing operation on the drawing interface 30. In the embodiment, the processing unit 14 identifies a trace of the drawing operation on the drawing interface 30, and regards the trace as the locking password, and stores the locking password in the data storage 11. In the embodiment, the locking password is rectangular.

In step S23, the processing unit 14 associates the locking password with the file to lock the file.

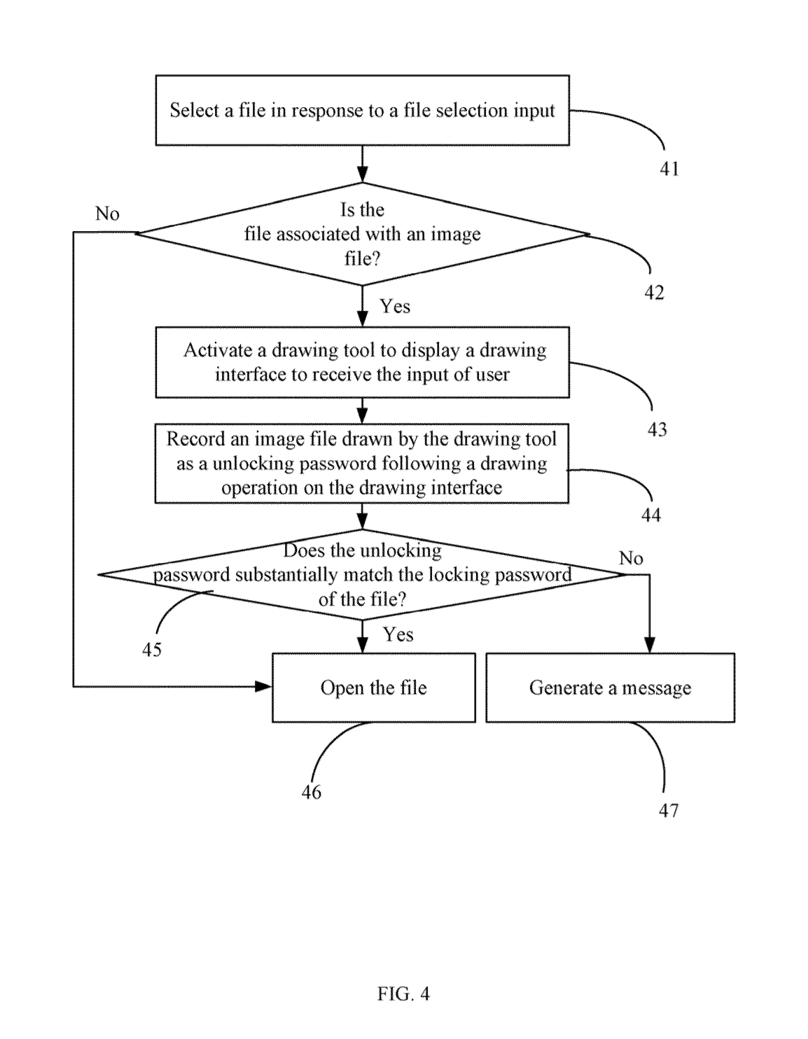

FIG. 4 is a flowchart of method to unlock the encrypted file in accordance with a first embodiment.

In step S41, the processing unit 14 selects a file in response to a file selection input.

In step S42, the processing unit 14 determines whether the file is associated with an image file, if the file is not associated with any image file, the procedure goes to step S46.

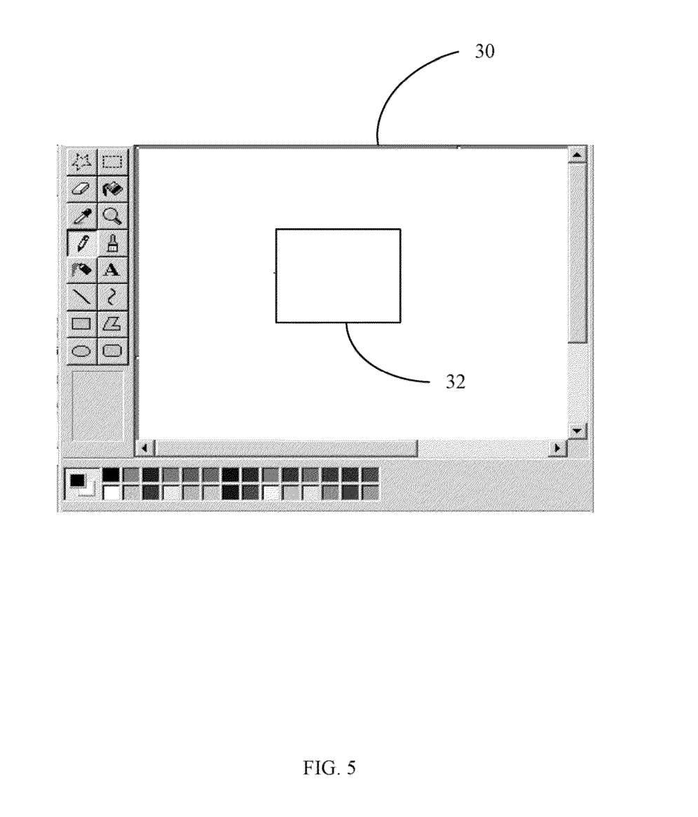

In step S43, if the file is associated with an image file, the processing unit 14 activates the drawing tool to display the drawing interface 30 (see FIG. 5) to receive the input of the user.

In step S44, the processing unit 14 records an image file drawn by the drawing tool as a unlocking password following a drawing operation on the drawing interface 30.

In step S45, the processing unit 14 determines whether the unlocking password 32 substantially matches the locking password 31 of the file.

In step S46, the processing unit 14 opens the file if the unlocking password 32 matches the locking password 31 of the file.

In step S47, the processing unit 14 generates a message if the unlocking password 32 does not match the locking password 31 of the file, such as a dialog box warning that the password is not correct.

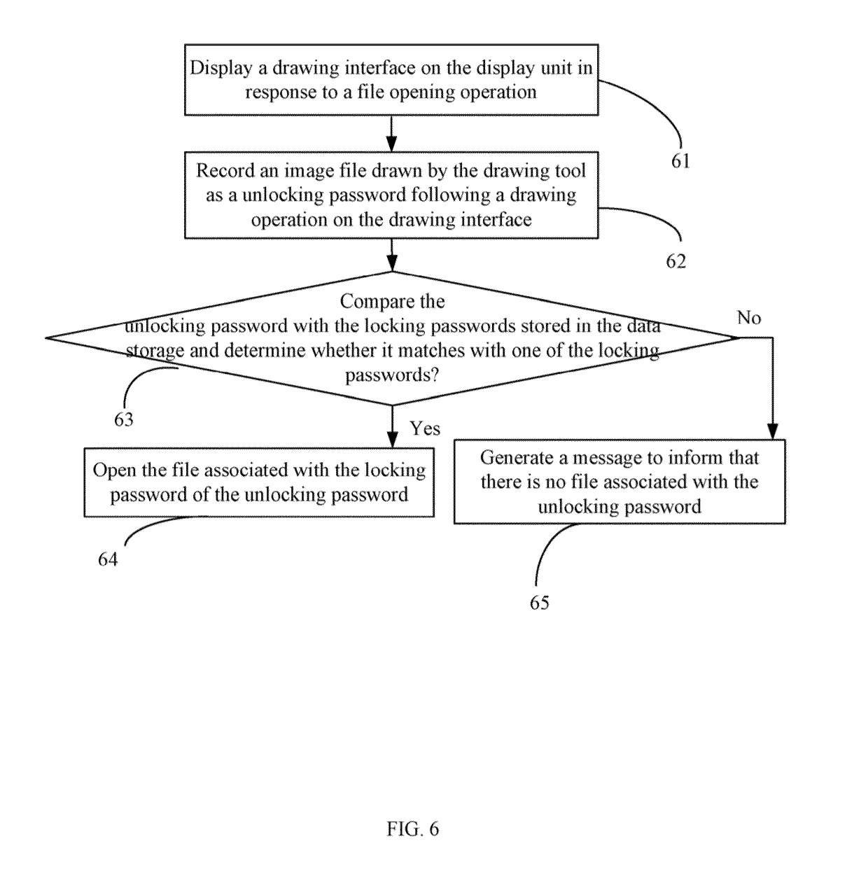

FIG. 6 is a flowchart of method to unlock the locked file according to a second embodiment.

In step S61, the processing unit 14 displays the drawing interface 30 on the display unit 12 in response to a file opening operation.

In step S62, the processing unit 14 records an image file drawn by the drawing tool as a unlocking password following a drawing operation on the drawing interface 30.

In step S63, the processing unit 14 compares the unlocking password 32 with the locking passwords 31 stored in the data storage 11 and determine whether it matches with one of the locking passwords?

In step S64, the processing unit 14 opens the file associated with the matched locking password of the unlocking password 32 if the matched locking password 32 of the unlocking password 32 exists.

In step S65, the processing unit 14 generates a message to inform that there is no file associated with the unlocking password 32 if no match is found.

In the embodiment, the match of the unlocking password 32 and the locking password 31 is determined by computing similarity between the unlocking password 32 and the locking password 31. If the similarity between the unlocking password 32 and the locking password 31 is a predetermined value, it can be determined that the unlocking password 32 substantially matches the locking password 31 if the similarity reaches or exceeds the predetermined value. The method for computing similarity between two image files is a familiar technology to the skilled persons in the art, so it's unnecessary to describe it here.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
a data storage for storing a plurality of files;
a display unit for displaying drawing interfaces; and
a processing unit for selecting a file requiring locking, activating a drawing tool to generate the drawing interface in response to an file locking operation, recording an image file drawn by the drawing tool as a locking password following a drawing operation on the drawing interface, and associating the file with the locking password to lock the file.

2. The electronic device as described in claim 1, wherein the processing unit selects a file in response to a file selecting operation, determines whether the selected file associates an image file in response to an file opening operation, activates a drawing tool to display the drawing interface if the selected file associates an image file, records an image file drawn by the drawing tool as a unlocking password following a drawing operation on the drawing interface, and opens the file if the unlocking password matches the locking password in the encryption file associated with the file.

3. The electronic device as described in claim 2, wherein the processing unit generates a message to inform that the password is not correct if the unlocking password does not match the locking password of the file.

4. The electronic device as described in claim 1, wherein the processing unit displays the drawing interface on the display unit in response to a file opening operation, records an image file drawn by the drawing tool as a unlocking password following a drawing operation on the drawing interface, compares the unlocking password with the locking password in the encryption image files stored in the data storage and determine whether it matches with one of the locking passwords, and opens the file associated with a matched locking password of the unlocking password if the matched locking password of the unlocking password exists.

5. The electronic device as described in claim 4, wherein the processing unit generates a message to inform that there is no file associated with the unlocking password if no match is found.

6. The electronic device as described in claim 2, wherein the match of the unlocking password and the locking password is determined by computing similarity between the unlocking password and the locking password, if the similarity between the unlocking password and the locking password is a predetermined value, the processing unit determines the unlocking password matches the locking password.

7. The electronic device as described in claim 4, wherein the match of the unlocking password and the locking password is determined by computing similarity between the unlocking password and the locking password, if the similarity between the unlocking password and the locking password is a predetermined value, the processing unit determines the unlocking password matches the locking password.

8. A method for encrypting files stored in an electronic device, comprising:
selecting one file need to be encrypted;
activating a drawing tool to generate a drawing interface in response to an encryption operation;
recording an image file drawn by the drawing tool as a locking password following a drawing operation on the drawing interface; and
associating the file with the locking password to lock the file.

9. The method as described in claim 8, further comprising:
selecting a file in response to a file selecting operation;
determining whether the selected file associates one image file in response to an file opening operation, activates a drawing tool to display the drawing interface if the selected file associates one image file;
recording an image file drawn by the drawing tool as a unlocking password following a drawing operation on the drawing interface; and
opening the file if the unlocking password matches the locking password associated with the file.

10. The method as described in claim 9, further comprising generating a message to inform that the password is not correct if the unlocking password does not match the locking password of the file.

11. The method as described in claim 8, further comprising:
displaying the drawing interface on the display unit in response to a file opening operation;
recording an image file drawn by the drawing tool as a unlocking password following a drawing operation on the drawing interface;
comparing the unlocking password with the locking password in the encryption image files stored in the data storage and determine whether it matches with one of the locking passwords; and
opening the file associated with a matched locking password of the unlocking password if the matched locking password of the unlocking password exists.

12. The method as described in claim 11, further comprising generating a message to inform that there is no file associated with the unlocking password if no match is found.

13. The method as described in claim 9, wherein the match of the unlocking password and the locking password is determined by computing similarity between the unlocking password and the locking password, if the similarity between the unlocking password and the locking password is a predetermined value, the processing unit determines the unlocking password matches the locking password.

14. The method as described in claim 11, wherein the match of the unlocking password and the locking password is determined by computing similarity between the unlocking password and the locking password, if the similarity between the unlocking password and the locking password is a predetermined value, the processing unit determines the unlocking password matches the locking password.
